(19) United States
(12) Patent Application Publication
(10) Pub. No.: US 2026/0181474 A1
(43) Pub. Date: Jun. 25, 2026

(54) CONGESTION-AWARE CELLULAR NETWORK OFFLOADING

(71) Applicant: AT&T Intellectual Property I, L.P., Atlanta, GA (US)

(72) Inventors: Yupeng Jia, South Pasadena, CA (US); Hongyan Lei, Plano, TX (US); Feng Wang, Austin, TX (US)

(21) Appl. No.: 18/988,872

(22) Filed: Dec. 19, 2024

(51) Int. Cl. H04W 28/02; H04W 24/08; H04W 24/10

(52) U.S. Cl. CPC H04W 28/0289; H04W 24/08; H04W 24/10

(57) ABSTRACT

A processing system including at least one processor deployed in a cellular access network may obtain load information associated with a plurality of non-cellular wireless access networks, where at least a portion of the load information is obtained from a plurality of endpoint devices through a non-cellular network interworking function. The processing system may next configure a machine learning model in accordance with the load information to generate an offload policy for an area that includes the plurality of non-cellular wireless access points. The processing system may then transmit an instruction to at least one endpoint device to cause the at least one endpoint device to connect to one of the plurality of non-cellular wireless access networks in accordance with the offload policy.

The present disclosure relates generally to cellular network operations, and more particularly to methods, non-transitory computer-readable media, and apparatuses for configuring a machine learning model in accordance with load information associated with a plurality of non-cellular wireless access networks to generate an offload policy for an area that includes a plurality of non-cellular wireless access points.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Despite the success of 5G network deployments, Wi-Fi offloading remains a ubiquitous option for network operators to alleviate cellular network congestion and improve service quality. It involves directing mobile data traffic from cellular to Wi-Fi when possible to provide network congestion relief, enhanced indoor coverage, etc.

### SUMMARY

In one example, the present disclosure discloses a method, computer-readable medium, and apparatus for configuring a machine learning model in accordance with load information associated with a plurality of non-cellular wireless access networks to generate an offload policy for an area that includes a plurality of non-cellular wireless access points. For example, a processing system including at least one processor deployed in a cellular access network may obtain load information associated with a plurality of non-cellular wireless access networks, where at least a portion of the load information is obtained from a plurality of endpoint devices through a non-cellular network interworking function. The processing system may next configure a machine learning model in accordance with the load information to generate an offload policy for an area that includes the plurality of non-cellular wireless access points. The processing system may then transmit an instruction to at least one endpoint device to cause the at least one endpoint device to connect to one of the plurality of non-cellular wireless access networks in accordance with the offload policy.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for configuring a machine learning model in accordance with load information associated with a plurality of non-cellular wireless access networks to generate an offload policy for an area that includes a plurality of non-cellular wireless access points; and

FIG. 3 illustrates a high level block diagram of a computing device specifically programmed to perform the steps, functions, blocks and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for configuring a machine learning model in accordance with load information associated with a plurality of non-cellular wireless access networks to generate an offload policy for an area that includes a plurality of non-cellular wireless access points. To illustrate, Wi-Fi offloading remains a successful option for network operators to alleviate cellular network congestion and improve service quality. It involves directing mobile data traffic from a cellular network to a Wi-Fi network when possible to provide network congestion relief, enhanced indoor coverage, etc. However blindly directing endpoint devices to Wi-Fi may not always improve user experience. In this regard, examples of the present disclosure consider the Wi-Fi and cellular network capabilities as well as network loading when implementing automated network-directed offloading.

In particular, examples of the present disclosure provide intelligent traffic balancing based on exchange of network loading information. In accordance with the present disclosure, load metrics, or load information of non-cellular wireless access networks may include channel utilization information, a number of connected devices, a throughput, a signal strength, e.g., a received signal strength indicator (RSSI), and so forth. In one example, the present disclosure may include an enhancement to an evolved packet data network gateway (ePDG) and/or non-3GPP interworking function (N3IWF) functionality, and/or enhancements to 3^{rd} Generation Partnership Project (3GPP) or Institute of Electrical and Electronics Engineers (IEEE) protocols to support the exchanging of non-cellular wireless network (e.g., IEEE 802.11/Wi-Fi network) loading information. In one example, the present disclosure may include an open element in an Open Radio Access Network (ORAN) architecture to interface with Wi-Fi network(s) to maximize high bandwidth spectrum utilization (e.g., Frequency Range 2 (FR2)) over Wi-Fi depending on location, use cases, etc.

In one example, multiple gNBs may be connected to one or more ePDG/N3IWF instances to dynamically select a Wi-Fi network with available capacity. In one example, the present disclosure may implement a heat map of network loading to decide which Wi-Fi network and/or access point to direct an endpoint device for offloading from the 5G cellular access network. In one example, the present disclosure may implement a notification to present to a user of an endpoint device to indicate that an indirect path (i.e., Wi-Fi offloading) is being used to connect to the cellular core network. In addition, in one example, data usage through Wi-Fi access to the ePDG/N3IWF can be in customized modes, such as restricted, normal, high speed, etc. In other words, different Wi-Fi networks may be prioritized for different access modes. In one example, the present disclosure may enable a mesh of Wi-Fi access points (APs) of one or more non-cellular wireless networks to communicate and share load information with each other and/or with multiple gNBs.

In accordance with the present disclosure, an offloading controller in the radio access network may direct an endpoint device to find a least congested Wi-Fi AP for offloading (e.g., use a “heat map” or offload policy). To further illustrate, an offload policy may be generated using artificial intelligence (AI) and/or machine learning (ML)-based predictive analytics based on historical and real time data. For instance, examples of the present disclosure may predict network load at different non-cellular wireless networks in an area (e.g., with possible overlapping coverage with each other and with a cellular RAN), may predict signal quality, throughput, and/or other performance factors at particular locations within a coverage range of one or more Wi-FI APs, and may proactively manage the radio environment via automated offload decisions in accordance with an offload policy that is dynamically updated via AI/ML processes. In particular, the offload policy enables automated decision making for offloading endpoint devices/data traffic, with Wi-Fi network selection based on predictive insights and current network status.

In one example, before an endpoint device is connected to a Wi-Fi network, the endpoint device may perform periodic measurements of one or more available Wi-Fi APs, such as operating channel load, RSSIs, etc. The measurement data, e.g., load information, may be sent to the cellular RAN through a cellular air interface. In one example, the Wi-Fi measurements may be performed with 802.11k, u functions. Alternatively, or in addition, Wi-Fi network load information may be obtained via Access Network Query Protocol (ANQP) information elements (IEs). For instance, this may be used to obtain load information, such as available capacity, of OpenRoaming/Passpoint enabled APs without association with such Wi-Fi AP. The cellular RAN may receive the Wi-Fi network load information for multiple Wi-Fi networks in an area and may perform AI/ML data analytics using (1) real time (e.g., most recent) and historic access point channel load, throughput, RSSIs per location, and/or the like as well as (2) cellular network/RAN load/coverage data. This may include making forecasts/predictions of trends, building one or more heat maps/layers of Wi-Fi AP load, RSSI, endpoint device concentrations, etc., and generating an ML-based offload policy. In one example, the cellular RAN may implement the ML-based offload policy to make offload decisions and to send instructions to affected endpoint devices. Alternatively, or in addition, the cellular RAN may generate the offload policy and may push the offload policy to endpoint devices in the area. The endpoint devices may then implement the logic of the offload policy to determine whether or not to offload, to select the non-cellular wireless access network to which to offload/connect, and so forth.

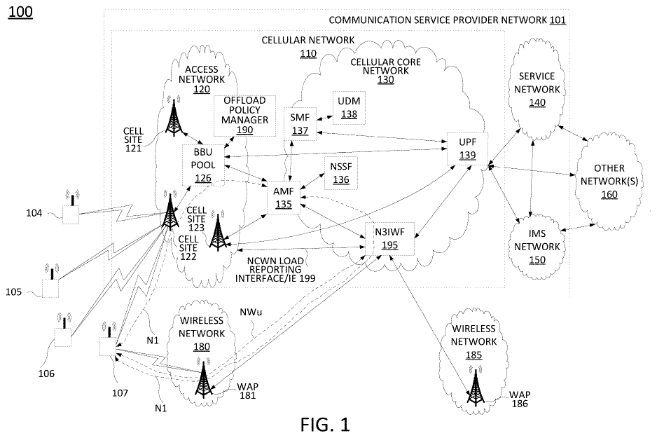

After an endpoint device connects to a particular Wi-Fi AP, the endpoint device may also conduct periodic measurements or otherwise obtain Wi-Fi network load information. The Wi-Fi network load information may be sent to the cellular RAN, e.g., through the N3IWF or through a cellular air interface as described above. Notably, by implementing offload decision logic in the RAN, latency may be reduced and the relevance and timeliness of the offload decision logic may be increased. In one example, the present disclosure may reduce extraneous measurements and measurement traffic, such as by directing endpoint devices to reduce measurement frequency. Thus, examples of the present disclosure help to relieve network pressure and optimize user experience through more optimal channeling of data traffic to Wi-Fi, leading to better load management and optimized resource utilization. In addition, examples of the present disclosure further enable cellular network operators to expand their capacity without additional spectrum. These and other aspects of the present disclosure are discussed in greater detail below in connection with the examples of FIGS. 1-3.

FIG. 1 illustrates an example network, or system 100 in which examples of the present disclosure may operate. In one example, the system 100 includes a communication service provider network 101. The communication service provider network 101 may comprise a cellular network 110 (e.g., a 5G network, a 5G/4G/Long Term Evolution (LTE) hybrid network, or the like), a service network 140, and an IP Multimedia Subsystem (IMS) network 150. The system 100 may further include other networks 160 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the progression of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, the base stations may have a distributed architecture comprising centralized units (CUs) (e.g., represented by BBU pool 126) and associated distributed units (DUs) (e.g., represented by BBU pool 126 and/or deployed at cell sites 121 and 122) and radio units (RUs) (e.g., deployed at cell sites 121 and 122). In one example, these components may be in accordance with an O-RAN architecture, e.g., an Open-CU (O-CU), an Open-DU (O-DU), an Open-RU (O-RU), or the like.

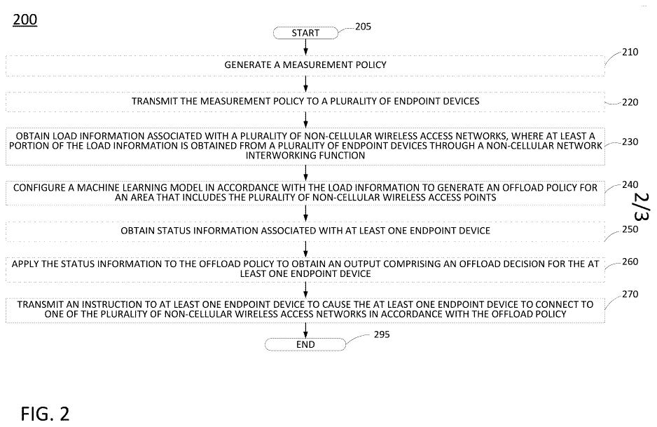

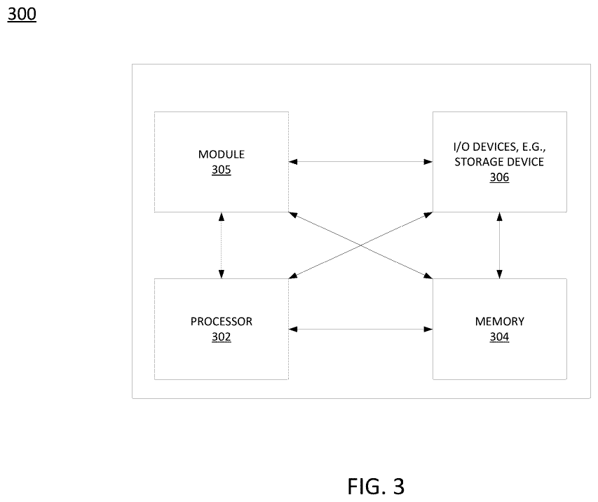

In accordance with the present disclosure, any one or more of cell sites 121-123 may be deployed with antenna and radio infrastructures, including multiple input multiple output (MIMO) capable radios, millimeter wave antennas, and so forth. Furthermore, in accordance with the present disclosure, a base station (e.g., cell sites 121-123 and/or baseband units within BBU pool 126) may comprise all or a portion of a computing system, such as computing system 300 as depicted in FIG. 3, and may be configured to provide one or more functions in connection with examples of the present disclosure for configuring a machine learning model in accordance with load information associated with a plurality of non-cellular wireless access networks to generate an offload policy for an area that includes a plurality of non-cellular wireless access points, such as illustrated and described in connection with the example method 200 of FIG. 2. For instance, an O-CU and/or an O-DU may include an offload policy manager 190 to generate an offload policy and/or to make offload decisions, to communicate offload decisions to endpoint devices (e.g., user equipment (UEs)) and/or to provide an offload policy to endpoint devices, and so forth. Alternatively, or in addition, the offload policy manager 190 may comprise a separate NF (e.g., a virtual network function (VNF)) instantiated in access network 120, e.g., an edge cloud.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the cellular core network 130 provides various functions that support wireless services in the 5G environment. In one example, cellular core network 130 is an Internet Protocol (IP) packet core network that supports both real-time and non-real-time service delivery across a 5G network, e.g., as specified by the 3GPP standards. In one example, cell sites 121 and 122 in the access network 120 are in communication with the cellular core network 130 via baseband units in BBU pool 126. As illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., a mobility management entity (MME), and so forth. In one example, SMF 137 may perform endpoint device IP address management, UPF selection, UPF configuration for endpoint device traffic routing to an external packet data network (PDN), charging data collection, quality of service (QoS) enforcement, and so forth. UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. UDM 138 may perform user identification, credential processing, access authorization, registration management, mobility management, subscription management, and so forth.

NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 160 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 160 may include different types of networks. In another example, the other networks 160 may be the same type of network. In one example, the other networks 160 may represent the Internet in general. In this regard, it should be noted that any one or more of service network 140, other networks 160, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs). For example, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

FIG. 1 also illustrates various endpoint devices 104-107, e.g., user equipment (UEs). Endpoint devices 104-107 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, endpoint devices 104-107 may each be equipped with one or more directional antennas, or antenna arrays (e.g., having a half-power azimuthal beamwidth of 120 degrees or less, 90 degrees or less, 60 degrees or less, etc.), e.g., multiple input-multiple output (MIMO) antenna(s) to receive multi-path and/or spatial diversity signals. Some or all of the endpoint devices 104-107 may also include a gyroscope and compass to determine orientation(s), a global positioning system (GPS) receiver for determining a location (e.g., in latitude and longitude, or the like), and so forth. In one example, some or all of the endpoint devices 104-107 may include a built-in/embedded barometer from which measurements may be taken and from which an altitude or elevation of the respective endpoint device may be determined. In one example, some or all of the endpoint devices 104-107 may also be configured to determine location/position from near field communication (NFC) technologies, such as Wi-Fi direct and/or other IEEE 802.11 communications or sensing (e.g., in relation to beacons or reference points in an environment), IEEE 802.15 based communications or sensing (e.g., “Bluetooth”, “ZigBee”, etc.), and so forth. In addition, in one example, each of the endpoint devices 104-107 may comprise all or a portion of a computing system, such as computing system 300 depicted in FIG. 3, and may be configured to perform one or more steps, functions, and/or operations in connection with examples of the present disclosure for configuring a machine learning model in accordance with load information associated with a plurality of non-cellular wireless access networks to generate an offload policy for an area that includes a plurality of non-cellular wireless access points, such as illustrated and described in connection with the example method 200 of FIG. 2.

As illustrated in FIG. 1, endpoint devices 104-107 may register and attach to cell site 122 to obtain network services from cellular network 110 and/or communication service provider network 101. This may include detecting a primary synchronization signal (PSS), secondary synchronization signal (SSS), physical broadcast channel (PBCH), and/or demodulation reference signal (DMRS), engaging a random access channel to report to the cell site 122 and establish a radio resource control (RRC) communication, transmitting a registration/attach request, performing authentication procedures, establishing a default protocol data unit (PDU) session, e.g., including bearer assignment, and so forth.

In one example, cellular core network 130 may also include a non-3GPP inter-working function (N3IWF) 195 (e.g., a non-cellular network interworking function). In particular, the N3IWF 195 enables PDU session establishment via a UPF (such as UPF 139) for endpoint devices connecting to other network(s) 160 through the cellular network 110 via trusted and untrusted non-cellular (e.g., non-3GPP) wireless access networks (e.g., IEEE 802.11/Wi-Fi networks). To illustrate, in one example, wireless access point (WAP) 181 in wireless network 180 may comprise an untrusted WAP. Thus, wireless network 180 may comprise an untrusted wireless network. In one example, WAP 181 may comprise a wireless router that may communicate with any of endpoint devices 104-107 or the like via an IEEE 802.11/Wi-Fi based link, e.g., a Y1 interface, and that may connect to N3IWF 195 via a Y2 interface.

As illustrated in FIG. 1, endpoint device 107 may connect to N3IWF 195 via a secure tunnel, e.g., an IPsec tunnel, where traffic carried via the secure tunnel is passed via the WAP 181, but is indecipherable to the WAP 181. For example, the payload data may be encrypted using an encryption key, or keys, which may be held by endpoint device 107 and N3IWF 195, but which WAP 181 does not possess. In one example, the secure tunnel between the endpoint device 107 and N3IWF 195 may comprise a NWu interface. To further illustrate, in an offloading scenario in which endpoint device 107 may have an existing connection to cellular network 110, e.g., via cell site 122, endpoint device 107 may transmit a PDU session establishment request to N3IWF 195, which may forward the request to AMF 135. In turn, AMF 135 may transmit a session create/context request message to SMF 137. In one example, SMF 137 may verify the endpoint device 107 via a query and response sequence with UDM 138. Upon success, SMF 137 may notify AMF 135 of the PDU session create/context response. SMF 137 may also transmit a session establishment request to UPF 139 to establish a session for endpoint device 107. The UPF 139 may acknowledge to SMF 137 with a session establishment response. SMF 137 may then initiate an N1/N2 transfer request, e.g., to transfer an N1 interface (endpoint device 107 to AMF 135) from access network 120 to wireless network 180 and N3IWF 195 and an N2 interface between access network 120 and AMF 135 to an N2 interface between NWDAF 195 and AMF 135. The N3IWF 195 may transmit a PDU session establishment accept to UE 107, which may permit UE 107 to begin communicating with remote systems via N3IWF 195, UPF 139, and other network(s) 180. It should be noted that the foregoing description may be simplified and that other operations may be included in establishment of a PDU session via wireless network 180 and N3IWF 195, such as additional invocations to a policy control function (PCF), a charging function (CHF), and so forth.

For ease of illustration, only endpoint device 107 is illustrated as being attached to WAP 181 of wireless network 180 and having a PDU session established via N3IWF 195 and UPF 139. However, it should be understood that via a same or similar process, endpoint devices 104-106 (and/or others) may similarly attach to WAP 181, and may similarly establish PDU sessions via N3IWF 195 and UPF 139. Likewise, endpoint devices 104-107 (and/or others) may attach to WAP 186 of another nearby wireless network 185 (e.g., a non-cellular access network, such as an IEEE 802.11/Wi-Fi network). For instance, in an illustrative example, wireless network 180/WAP 181 and wireless network 185/WAP 186 may have overlapping or partially overlapping coverage with each other and also with cell site 122. In one example, cell site 123 may also provide overlapping or partially overlapping coverage with wireless network 180/WAP 181 and/or wireless network 185/WAP 186.

In accordance with the present disclosure, the cellular network 110/communication service provider network 101 may make intelligent decisions as to whether and when to offload endpoint devices to non-cellular wireless access networks, such as wireless access networks 180 and 185. In one example, this functionality may be delegated primarily to the radio access network (RAN). For instance, as illustrated in FIG. 1 offload policy manager 190 may be deployed in access network 120. To enable offload policy manager 190 to fulfill this purpose, various endpoint devices may collect and report non-cellular wireless access network load information. For instance, referring again to endpoint device 107, in one example, cellular network 110 may maintain the existing connection for endpoint device 107 via cell site 122, e.g., for periodic reporting of non-cellular wireless access network load information, for receiving updated offload instructions and/or offload policy, and so forth. In particular, endpoint device 107 may report load information of wireless network 180 to offload policy manager 190 via cell site 122. Alternatively, or in addition, endpoint device 107 may report non-cellular wireless access network load information via N3IWF 195. In this regard, a new interface, e.g., a non-cellular wireless network (NCWN) load reporting interface 199 and/or a new information element (IE) may be provided for N3IWF 195 to provide non-cellular wireless access network load information from endpoint devices to access network 120 (e.g., to a RAN element, such as offload policy manager 190). In another example, an existing session for endpoint device 107 via cell site 122 may be released (e.g., endpoint device 107 may exit a RRC connected state) when endpoint device 107 is offloaded to wireless network 180, in which case load information of wireless network 180 may be reported exclusively via N3IWF 195.

In one example, endpoint device 107 may collect measurements for one or more types of load information, such as throughput (e.g., uplink, downlink, or both), RSSIs per location, a call drop rate, a call block rate, a packet drop rate, jitter, etc. In one example, endpoint device 107 may time stamp each measurement and may also tag/stamp each measurement with a location. Alternatively, or in addition, endpoint device 107 may obtain load information of wireless network 180 via ANQP information elements (IEs), e.g., from WAP 181. It should also be noted that in one example, endpoint device 107 may also take measurements or otherwise obtain load information from one or more non-cellular wireless access networks that endpoint device 107 is not attached to (such as wireless network 185/WAP 186). For instance, ANQP IEs may be obtained from WAP 186 without attaching to wireless network 185/WAP 186. Similarly, endpoint device 107 may measure a received signal strength from WAP 186, e.g., at one or more locations within a coverage area of wireless network 185, without initiating a network attach procedure. It should be further noted that endpoint devices 104-106 may similarly gather and report load information from one or more non-cellular wireless access networks (e.g., wireless networks 180 and 185) and may report via one or more of cell sites 121-123 and/or via N3IWF 195, depending upon whether a respective endpoint device is currently attached to access network 120 or has been offloaded to a non-cellular wireless access network.

In one example, endpoint devices 104-107 (and/or others) may collect and report non-cellular wireless access network load information according to a measurement policy that specifies whether and when to collect such load information. For instance, offload policy manager 190 may create such a policy or policies (e.g., different policies for different endpoint devices and/or different classes or other groups of endpoint devices) and may transmit updates to such a policy (or policies) to endpoint devices, e.g., on a period basis or otherwise. Such a measurement policy may include a measurement frequency for a collection of the load information by the plurality of endpoint devices or measurement probabilities for a collection of the load information by the plurality of endpoint devices for locations within an area of responsibility of the offload policy manager 190 (e.g., an area including at least the coverage area(s) of cell sites 121-123 and wireless networks 180 and 185). For example, if measurements of RSSI for a given non-cellular wireless access network from the endpoint devices at a same location are stable over time, it is less important for the endpoint devices to continue to collect this same type of measurement at the same location. In contrast, if other locations have a dynamic radio environment and the RSSI is known to be different at different times of day, days of the week, and/or in response to the presence of obstructions or other interference, etc., then it may be beneficial to obtain measurements more often for such location(s). In addition, the measurement frequency can be similarly set by offload policy manager 190 based upon coarse estimates of how often updated measurements are desired to be obtained and the likelihood that endpoint devices may be at locations where updated measurements may be desired. In addition, some locations may have heavy traffic and thus it may be relatively easy to obtain many measurements. Thus, these locations may have a low measurement probability. Other locations may have less traffic, and thus the measurement probability may be set higher to ensure that fresh measurements/samples are collected. In one example, a given endpoint device may execute the policy and determine whether it will or will not make a measurement at a location at a given time in accordance with the probability (e.g., if the probability is 25%, the endpoint device may generate a random number between 1 and 4. If the random number is 1, it may make take the measurement(s) and report, otherwise it may take no action).

In an illustrative example, offload policy manager 190 may control whether and when endpoint devices may be offloaded from access network 120 to non-cellular wireless access networks in an area of responsibility, such as wireless networks 180 and 185. In accordance with the present disclosure, offload policy manager 190 may make such determinations based upon non-cellular wireless access network load information that may be reported (e.g., real-time (e.g., most recent) and/or historic). For instance, offload policy manager 190 may generate and implement an offload policy that is based upon the non-cellular wireless access network load information. In addition, in one example, offload policy manager 190 may make such determinations further based upon cellular access network load information (e.g., associated with access network 120 and/or any one or more of cell sites 121-123). In this regard, offload policy manager 190 may obtain this additional information directly from elements of access network 120, e.g., cell sites 121-123 (e.g., RUs, DUs, and/or CUs), BBU pool 126 (e.g., CUs and/or DUs), and so forth. In one example, offload policy manager 190 may make such determinations further based upon one or more performance objectives of the network operator associated with access network 120, cellular network 110, or communication service provider network 101 in general. For instance, the network operator may have one or more objectives such as minimum uplink throughput per endpoint device, minimum downlink throughput per endpoint device, a power/energy saving objective, a maximum call drop rate, a maximum call blocking rate, and so forth.

In one example, the offload policy may comprise an artificial intelligence (AI) and/or machine learning (ML)-based model that has been trained to indicate offload decisions, e.g., within the area of responsibility of an offload policy manager 190. To illustrate, there may be a defined set of base stations and non-cellular wireless access networks and/or APs to which endpoint devices may attach in a given area. To further illustrate, in one example, a machine learning model (MLM) may be trained/configured to process an input vector including at least an endpoint device location and to generate an output comprising a selection of a particular access point (cellular base station and/or non-cellular wireless access network/AP) from among the available cellular base station(s) and/or non-cellular wireless access network(s)/AP(s). In one example, the input vector may further include one or more additional factors, such as a time of day, a day of the week, or other temporal factor(s), and/or endpoint device characteristics (e.g., device type, applications in use and/or installed, average data consumptions in a given lookback time window and/or for particular times of the day, days of the week, etc., a service level agreement (SLA) and/or device category, battery/charge level, usage, and/or availability, and so forth). In one example, the input vector may further include current (e.g., most recent) network status information, e.g., for wireless network 180/WAP 181, wireless network 185/WAP 186, and/or access network 120 (and/or any one or more of cell sites 121-123 thereof). For instance, such a MLM may be trained to account for historic trends, but at any given time, an optimal offloading decision may be more likely to be achieved when particularly taking into account the most recent/most up to date load information. Accordingly, in one example, this may be incorporated into the input vector at runtime (e.g., when making offload decisions for different endpoint devices). However, in another example, the network load information may be fully accounted for within the training of MLM. For instance, the MLM may be retrained periodically or otherwise, or may be updated on an ongoing basis, e.g., via reinforcement learning (RL) or the like, to keep the MLM current.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, offload policy manager 190 may train and deploy one or more offload policies, e.g., one or more trained MLMs (or “offload policy models”) to generate offload recommendations and/or instructions. For instance, a generative offload policy model may comprise a machine learning model, e.g., a generative MLM that may take an input vector comprising information about an endpoint device location (and in some examples additional information including: network load for one or more non-cellular wireless access networks, temporal factors, endpoint device characteristics, cellular network load information and/or other factors), and that may output a recommended/selected AP (cellular or non-cellular) for a given endpoint device to connect.

To further illustrate, MLMs of the present disclosure may include an ML-based generative model, such as a language model, e.g., a “large language model” (LLM). For instance, a ML-based generative model used in the present examples may comprise a generative adversarial network (GAN), a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models. For instance, a generative model, such as one of the foregoing, may be trained/configured to generate offload decisions (e.g., AP selections from among cellular and/non-cellular wireless APs) for respective endpoint devices in view of various factors, such as: endpoint device location (and in some examples additional information including: network load for one or more non-cellular wireless access networks, temporal factors, endpoint device characteristics (particularly device type and/or battery/charge level, usage, and/or availability), cellular network load information and/or other factors).

In one example, the present disclosure may fine-tune a LLM to provide high-level instructions for radio access network (RAN)/cellular network-specific issues. In addition, in one example, the present disclosure may further enhance such a fine-tuned MLM to provide concrete, actionable instructions, e.g., offload decisions (e.g., AP selections from among cellular and/non-cellular wireless APs). For instance, a generative LLM of the present disclosure may further include a retrieval augmented generation (RAG) process loop to index network equipment and/or network function vendor documentation, network operator internal documents, cellular technology technical standards, such as 3rd Generation Partnership Project (3GPP) technical standards (TS), or the like in a vector store, as well as current non-cellular access network load/status information and/or RAN load information (e.g., associated with access network 120 and/or any one or more of cell sites 121-123 and/or BBU pool 126 thereof). In one example, input data for such a LLM-based generative model may include converting categorical or numerical data to text form, as well as vectorization of textual data to vectors (e.g., via word2vec, doc2vec, Global Vectors for Word Embedding (GloVe), or the like, using n-grams, and so forth). In one example, tailored prompts may be used in connection with a generative MLM of the present disclosure, e.g., to obtain outputs that may comprise instructions in useable format with respect to other network functions, such as outputs formatted for 3GPP/5G standards compliant communications, IEEE 802.11 standards compliant communications, or the like. For instance, the prompt may explicitly request a selection of an AP from among a plurality of available APs, e.g., where the prompt may list the available APs and/or where the available APs and further information about the APs, e.g., load information, etc. may be appended as RAG content.

In one example, offload policy manager 190 may train and deploy such an offload policy, and may generate offload decisions and instructions to endpoint devices to initiate offloading. For instance, offload policy manager 190 may re-evaluate respective endpoint devices periodically or otherwise for AP assignment/offload determination. However, it should be noted that as service levels may change as an endpoint device moves in an area, normal handover procedures may be initiated. For instance, endpoint device 107 may be directed to wireless network 180/WAP 181. Endpoint device 107 may remain attached to wireless network 180/WAP 181 until endpoint device 107 moves out of range or is at the coverage edge of wireless network 180/WAP 181 where performance begins to deteriorate. In such case, endpoint device 107 may initiate a handover, or the cellular network 110 may initiate a handover in the normal course, regardless of any prior offloading decision/AP assignment via offload policy manager 190.

However, in another example, offload policy manager 190 may establish an offload policy (e.g., training an MLM) as described above, but may deploy the offload policy to endpoint devices to implement offload logic/AP selection individually. For instance, in one example, offload policy manager 190 may create a light version of the MLM that may operate on a given endpoint device to allow the endpoint device to obtain a same or similar output, e.g., an offload decision/AP assignment as described above. In one example, such a light MLM may be trained to use a lesser number of input features in an input vector, e.g., to keep the operating footprint of the MLM manageable. Alternatively, or in addition, the offload policy manager 190 may “pre-evaluate” for offload decisions, e.g., for particular locations, and for particular endpoint device types, categories or classes of endpoint devices and/or users, or the like. For instance, each location may have an assigned probability for selecting a particular access point, with different probabilities for different available access points. A given endpoint device may then select a particular AP (cellular or non-cellular) in accordance with the probabilities.

In this regard, the offload policy that may be provided to a particular endpoint device may comprise a policy map or “heat map.” In addition, an endpoint device comprising a mobile smartphone may have a first map with a first set of probabilities per location, while an endpoint device comprising an augmented reality device (e.g., smart glasses) may have a second map with a second set of probabilities per location, and so on. In one example, a policy map may include a formula or rule set to further permit/enable endpoint devices to select a given AP from among available cellular and non-cellular APs based upon current network load information (e.g., including RSSI and/or capacity, etc.). For instance, such a formula may allow for a given endpoint device to select from three available APs with probabilities of 70%, 20%, and 10%, respectively. However, if the load is higher than normal or signal strength is worse than normal for the AP having 70% probability, a weighting factor proportional to the degraded signal strength and/or a weight factor proportional to the higher load may be applied to adjust this probability lower (and hence raise the probabilities for the other two available APs). Likewise, in one example, the offload policy may account for and/or permit an override of initial probabilities based upon factors such as SLAs or the like (e.g., some users/endpoint devices may be entitled to cellular connections regardless of a network operator's desire to offload; conversely, some SLAs may require certain endpoint devices to comply with offload requests/instructions, e.g., in exchange for a discounted service or earned credits, etc.). Similarly, in one example, an endpoint device's remaining available charge/battery level may indicate that adjustment to the defaults may be warranted. For example, endpoint devices with low battery may be preferentially directed to non-cellular (e.g., Wi-Fi) access, which may generally be associated with lower energy consumption.

It should again be noted that endpoint devices may continue to be tasked with collecting load information of non-cellular wireless access points and reporting to offload policy manager 190. Thus, offload policy manager 190 may update the offload policy (e.g., re-train a MLM or re-adjusting/fine tuning a LLM) periodically or otherwise in accordance with ongoing collected load information, and/or may have current/most recent network load information to use in connection with retrieval augmented generation (RAG) as supplemental prompt content/additional input(s). In addition, in one example, the present disclosure may automatically generate labels (e.g., in an unsupervised manner) based upon endpoint device feedback regarding past offload decisions/AP assignments. For instance, at a given location and at a given time, offload policy manager 190 and/or endpoint device 107 may select to offload endpoint device 107 to wireless network 180/WAP 181. However, a user of endpoint device 107 may override this decision by disabling Wi-Fi on the endpoint device 107. Thus, for example, a detection of the disabling of Wi-Fi at the endpoint device 107 and/or a detection of a re-connection to access network 120 (e.g., within a certain period of time following the offloading, such as within one minute, two minutes, five minutes, etc.) may be considered as a negative label of an “incorrect” decision/output of an MLM embodying the offload policy. Alternatively, or in addition, a label of a “correct” decision may be applied when no such reactive action is taken. Thus, over time, the MLM may be adapted to generate better output decisions.

In addition, the foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For instance, intermediate devices and links between cell sites 121-123, AMF 135, NSSF 136, SMF 137, UDM 138, and/or UPF 139, and other components of system 100 are omitted for clarity, such as additional routers, switches, gateways, and the like. Alternatively, or in addition, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), a RAN intelligent controller (RIC), and other application functions (AFs).

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network). For instance, in non-standalone (NSA) mode architecture, LTE radio equipment may continue to be used for cell signaling and management communications, while user data may rely upon a 5G new radio (NR), including millimeter wave communications, for example. Thus, for instance, in accordance with the present disclosure, cellular core network 130 may further include other types of wireless network components e.g., 2G network components, 3G network components, 4G/Long Term Evolution (LTE) network components, etc. In other words, cellular core network 130 may comprise an integrated network, e.g., including any two or more of 2G-6G infrastructures and technologies, and the like. In one particular example, N3IWF 195 may comprise an evolved packet data gateway (ePDG), a trusted wireless local area network (WLAN) authentication, authorization, and accounting (AAA) proxy (TWAP), and a trusted WLAN access gateway (TWAG). In other words, N3IWF 195 may comprise a device that is configured to provide functions of all of an ePDG, a TWAP and a TWAG. In one example, ePDG functionality of the N3IWF 195 may process traffic from endpoint devices accessing the EPC network 130 via untrusted wireless networks (e.g., IEEE 802.11/Wi-Fi networks), while TWAP/TWAG functionality of shared gateway 141 may process traffic from endpoint devices accessing the EPC network via trusted wireless networks (e.g., IEEE 802.11/Wi-Fi networks).

In addition, access network 120 may include both 4G/LTE and 5G/NR radio access network infrastructure. For example, access network 120 may include 4G/LTE base station equipment, e.g., an eNodeB. In addition, access network 120 may include cell sites comprising both 4G and 5G base station equipment, e.g., respective antennas, feed networks, baseband equipment, and so forth. Similarly, in one example, any one or more of cell sites 121-123 may comprise 2G, 3G, 4G and/or LTE radios, e.g., in addition to 5G new radio (NR), or gNB functionality. For instance, in various examples, the present disclosure may further include the use of an inter-radio access technology (inter-RAT) air interface, e.g., with primary and secondary cell groups and/or split bearers or the like. Thus, these and other modifications are all contemplated within the scope of the present disclosure.

FIG. 2 illustrates a flowchart of an example method 200 for configuring a machine learning model in accordance with load information associated with a plurality of non-cellular wireless access networks to generate an offload policy for an area that includes a plurality of non-cellular wireless access points, in accordance with the present disclosure. In one example, steps, functions and/or operations of the method 200 may be performed by a device as illustrated in FIG. 1, e.g., a processing system comprising a base station, a BBU, a CU, a DU, and/or edge computing infrastructure, etc. (e.g., hosting a VNF comprising an offload policy manager), or collectively via a plurality devices in FIG. 1, such as a base station, a BBU, a CU, a DU, edge computing infrastructure, etc., in conjunction with a different one of such components and/or any one or more other components in FIG. 1, such as a N3IWF, etc.). In one example, the steps, functions, or operations of method 200 may be performed by a computing device or system 300, and/or a processing system 302 as described in connection with FIG. 3 below. For instance, the computing device or system 300 may represent at least a portion of device or system deployed in a cellular network that is configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system, such as processing system 302. The method 200 begins in step 205 and may proceed to optional step 210 or to step 230.

At optional step 210, the processing system (e.g., deployed in a wireless/cellular network and comprising: a base station, a BBU, a CU and/or a DU (e.g., of a gNodeB/gNB), and/or edge computing infrastructure, or the like) may generate at least one measurement policy, where the at least one measurement policy specifies at least one of: (1) a measurement frequency for a collection of load information associated with a plurality of non-cellular wireless access networks by a plurality of endpoint devices, or (2) measurement probabilities for a collection of the load information by the plurality of endpoint devices for locations within an area associated with a cellular access network and the plurality of non-cellular access networks. In one example, the at least one measurement policy may be based upon one or more variability measures associated with the load information. For instance, the load information may be collected on an ongoing basis and the at least one measurement policy may be generated/updated based upon recent measurements. For instance as noted above, if measurements of RSSI for a given non-cellular wireless access network from endpoint devices at a same location are stable over time, it is less important for the endpoint devices to continue to collect this same measurement at the same location. In addition, the measurement frequency can be similarly set based upon coarse estimates of how often updated measurements are desired to be obtained and the likelihood that endpoint devices may be at locations where updated measurements may be desired, and so forth.

At optional step 220, the processing system may transmit the at least one measurement policy to at least one of the plurality of endpoint devices. It should be noted that in one example, different measurement polices may be disseminated to different endpoint devices. For example, it may be beneficial to have only one or a few endpoint devices reporting on operating channel load indicator per non-cellular access network (and/or per AP) since this will not change depending on location. However, in one example, each endpoint device may report RSSI per location. Thus, the processing system at step 210 may have a target number of measurements of a particular type, and may select endpoint devices or classes of endpoint devices to collect measurements of such type (or not), or may have different probabilities of collecting measurements of such type.

At step 230, the processing system obtains the load information associated with the plurality of non-cellular wireless access networks. In one example, at least a portion of the load information may be obtained from a plurality of endpoint devices through a non-cellular network interworking function (e.g., a non-3GPP interworking function (N3IWF) or the like). In one example, at least a second portion of the load information may be obtained from one or more of the plurality of endpoint devices via cellular access network connections. In one example, the load information may be obtained from the plurality of endpoint devices in accordance with the at least one measurement policy. For instance, in one example, a given endpoint device may execute a respective measurement policy and may determine whether it will or will not make a measurement at a location at a given time in accordance a probability as indicated in the measurement policy. In one example, the load information associated with the plurality of non-cellular wireless access networks may comprise a plurality of load information reports. For instance, each load information report of the plurality of load information reports may include an identifier of a non-cellular access point of the plurality of non-cellular access points and a reporting endpoint device location. In one example, each load information report may further include at least one of: an operating channel load indicator or a received signal strength indicator.

In one example, the “measuring” may include obtaining Access Network Query Protocol (ANQP) information elements (IEs) according to the measurement policy. In other words, the plurality of endpoint devices may obtain operating channel load indicators and/or other aspects of the load information via the ANQP IEs. For instance, ANQP IEs (or other load information sharing by non-cellular wireless access networks) may be used to obtain load information, such as available capacity of one or more non-cellular wireless networks. In addition, the endpoint devices may report the load information, whether obtained via ANQP IEs and/or via direct measurements by the endpoint devices, for receipt by the processing system at step 230. In one example, the load information may be further received from one or more of the plurality of non-cellular wireless access networks. For instance, in one example, non-cellular wireless networks/APs may have direct reporting of load information to the processing system, e.g., via the N3IWF.

At step 240, the processing system configures a machine learning model (MLM) in accordance with the load information to generate an offload policy for an area that includes the plurality of non-cellular wireless access points. For instance, in one example, the MLM may comprise a generative MLM as discussed above, such as a language model, e.g., a LLM, a generative adversarial network (GAN), and so forth. In still other examples, the MLM (e.g., a generative MLM) may comprise a CNN, a RNN, a decision tree, and so forth. In one example, the configuring of the MLM may include training the MLM with labeled examples (e.g., from the load information, some samples/records of which may be labeled in accordance with user feedback of past decisions to offload or not offload (and where the user may accept the automated offload decision or may override the decision, e.g., by disabling Wi-Fi at an endpoint device, or the like)). Alternatively, or in addition, in one example, the configuring of the MLM may include fine tuning the MLM with the load information (and in some examples with additional features, such as cellular network load information, endpoint device characteristics (e.g., device type, status, etc.), and so forth). Alternatively, or in addition, in one example, the configuring of the MLM may include applying a retrieval augmented generation (RAG) content as supplemental prompt content/input. In one example, the MLM may comprise/represent the offload policy. In another example, the offload policy may be generated by applying various synthetic inputs to the MLM, obtaining the outputs, and generating a policy map as described above (e.g., in such an example, the offload policy may comprise the policy map).

At optional step 250, the processing system may obtain status information associated with at least one endpoint device (e.g., which may or may not be one of the plurality of endpoint devices previously reporting load information). For instance, the status information may include a location of the at least one endpoint device (e.g., at least one location of the at least one endpoint device). In one example, the status information may further include battery life information of the at least one endpoint device (e.g., remaining available battery/charge, and/or a status of whether connected to a power grid/external power source, etc.). In one example, the status information may further include offload preferences associated with the at least one endpoint device. For instance, a user may strongly dislike Wi-Fi offload (even if the WiFi network is able to provide superior performance), but the cellular network may still be motivated to offload the at least one endpoint device of the user due to a performance issue. In some cases, the cellular network may override the user preference since it may just be a preference. In another example, the endpoint device may have a SLA that guarantees that the endpoint device may obtain cellular access network direct connectivity when available (e.g., no offloading, or no offloading to untrusted non-cellular access networks, etc.). In still another example, the status information associated with the at least one endpoint device may alternatively or additionally include one or more of: a device type, an offload priority (e.g., devices that have not been offloaded recently may be offloaded with greater likelihood/bias than devices that have more recently and/or more frequently been offloaded), and so forth.

At optional step 260, the processing system may apply the status information to the offload policy to obtain an output comprising an offload decision for the at least one endpoint device, where the offload decision comprises a decision for the at least one endpoint device to connect to the one of the plurality of non-cellular wireless access networks. For instance, as noted above, in one example, the processing system may train and implement the offload policy, where the offload policy may comprise a MLM that may be configured to process an input vector including endpoint device status (e.g., including at least a location of the at least one endpoint device) and to generate an output comprising a selection of an AP from among a plurality of available cellular and non-cellular wireless APs. As noted above, in various examples, the input vector may further include other aspects of endpoint device status/endpoint device characteristics, such as: device type, applications in use and/or installed, average data consumption in a given lookback time window and/or for particular times of the day, days of the week, etc., a service level agreement (SLA) and/or device category, battery/charge level, usage, and/or availability, and so forth. In one example, the input vector may further include one or more additional factors, such as a time of day, a day of the week, or other temporal factor(s), and current (e.g., most recent) network status information. For instance, such a MLM/offload policy may be trained to account for historic trends, but at any given time, an optimal offloading decision may be more likely to be achieved when particularly taking into account the most recent/most up to date load information. Accordingly, in one example, this may be incorporated into the input vector at runtime (e.g., when making offload decisions for different endpoint devices). However, in another example, the network load information may be fully accounted for within the training of MLM. For instance, the MLM may be retrained periodically or otherwise, or may be updated on an ongoing basis, e.g., via reinforcement learning (RL) or the like, to keep the MLM current.

At step 270, the processing system transmits an instruction to the at least one endpoint device to cause the endpoint device to connect to one of the plurality of non-cellular wireless access networks in accordance with the offload policy. For instance, in one example, the instruction may identify the one of the plurality of non-cellular wireless access networks (e.g., which may be determined by the processing system in the preceding optional step 260). In another example, the instruction may comprise the offload policy, e.g., where the at least one endpoint device may be configured to select the one of the plurality of non-cellular wireless access networks in accordance with the offload policy. For instance, as noted above, in one example, the processing system may generate a policy map (e.g., an offload policy) by generating the MLM and then applying various inputs to the MLM to obtain percentages/probabilities for connecting to one or more APs at a given location (and in some examples for a given time, for a given endpoint device type, etc.). The endpoint device may then determine its location (and/or other aspects of device status, such as remaining battery/charge, etc.) and may select an AP in accordance with the probabilities indicated in the policy map.

Following step 270, the method 200 proceeds to step 295 where the method 200 ends.

It should be noted that the method 200 may be expanded to include additional steps or may be modified to include additional operations with respect to the steps outlined above. For example, the method 200 may be repeated on an ongoing basis to perform steps 230-270, steps 210-270, etc. In one example, the method 200 may be expanded to further include collecting labels/feedback from endpoint devices for policy updating/MLM retraining, and so forth. In one example, the method 200 may be expanded or modified to include steps, functions, and/or operations, or other features described in connection with the example(s) of FIG. 1, or as described elsewhere herein. Thus, these and other modifications are all contemplated within the scope of the present disclosure.

In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for configuring a machine learning model in accordance with load information associated with a plurality of non-cellular wireless access networks to generate an offload policy for an area that includes a plurality of non-cellular wireless access points, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like). In accordance with the present disclosure input/output devices 306 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for configuring a machine learning model in accordance with load information associated with a plurality of non-cellular wireless access networks to generate an offload policy for an area that includes a plurality of non-cellular wireless access points (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for configuring a machine learning model in accordance with load information associated with a plurality of non-cellular wireless access networks to generate an offload policy for an area that includes a plurality of non-cellular wireless access points (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor deployed in a cellular access network, load information associated with a plurality of non-cellular wireless access networks, wherein at least a portion of the load information is obtained from a plurality of endpoint devices through a non-cellular network interworking function;
configuring, by the processing system, a machine learning model in accordance with the load information to generate an offload policy for an area that includes the plurality of non-cellular wireless access points; and
transmitting, by the processing system, an instruction to at least one endpoint device to cause the at least one endpoint device to connect to one of the plurality of non-cellular wireless access networks in accordance with the offload policy.

2. The method of claim 1, wherein the load information is further received from one or more of the plurality of non-cellular wireless access networks.

3. The method of claim 1, wherein the instruction comprises the offload policy, wherein the at least one endpoint device is configured to select the one of the plurality of non-cellular wireless access networks in accordance with the offload policy.

4. The method of claim 1, wherein the instruction identifies the one of the plurality of non-cellular wireless access networks.

5. The method of claim 4, further comprising:
obtaining status information associated with the at least one endpoint device; and
applying the status information to the offload policy to obtain an output comprising an offload decision for the at least one endpoint device, wherein the offload decision comprises a decision for the at least one endpoint device to connect to the one of the plurality of non-cellular wireless access networks.

6. The method of claim 5, wherein the status information comprises a location of the at least one endpoint device.

7. The method of claim 6, wherein the status information further comprises battery life information of the at least one endpoint device.

8. The method of claim 6, wherein the status information further comprises an offload preference associated with the at least one endpoint device.

9. The method of claim 1, wherein the load information associated with the plurality of non-cellular wireless access networks comprises a plurality of load information reports, wherein each load information report of the plurality of load information reports comprises:
an identifier of a non-cellular access point of the plurality of non-cellular access points; and
a reporting endpoint device location.

10. The method of claim 9, wherein each load information report further comprises at least one of:
an operating channel load indicator; or
a received signal strength indicator.

11. The method of claim 10, wherein the plurality of endpoint devices obtain the operating channel load indicators via access network query protocol information elements.

12. The method of claim 1, further comprising:
generating a measurement policy, wherein the measurement policy specifies at least one of:
a measurement frequency for a collection of the load information by the plurality of endpoint devices; or
measurement probabilities for a collection of the load information by the plurality of endpoint devices for locations within a second area associated with the cellular access network and the plurality of non-cellular access networks.

13. The method of claim 12, further comprising:
transmitting the measurement policy to the plurality of endpoint devices, wherein the load information is obtained from the plurality of endpoint devices in accordance with the measurement policy.

14. The method of claim 12, wherein the measurement policy is based upon one or more variability measures associated with the load information.

15. The method of claim 1, wherein the processing system is deployed in a gNodeB centralized unit.

16. The method of claim 1, wherein the processing system is deployed in an edge computing infrastructure of the cellular access network.

17. The method of claim 1, wherein the machine learning model comprises a generative machine learning model.

18. The method of claim 17, wherein the configuring of the machine learning model comprises at least one of:
training the machine learning model with labeled examples;
fine tuning the machine learning model with the load information; or
applying a retrieval augmented generation content as supplemental prompt content.

19. A non-transitory computer-readable medium storing instructions which, when executed by a processing system including at least one processor deployed in a cellular access network, cause the processing system to perform operations, the operations comprising:
obtaining load information associated with a plurality of non-cellular wireless access networks, wherein at least a portion of the load information is obtained from a plurality of endpoint devices through a non-cellular network interworking function;
configuring a machine learning model in accordance with the load information to generate an offload policy for an area that includes the plurality of non-cellular wireless access points; and
transmitting an instruction to at least one endpoint device to cause the at least one endpoint device to connect to one of the plurality of non-cellular wireless access networks in accordance with the offload policy.

20. An apparatus comprising:
a processing system including at least one processor; and
a non-transitory computer-readable medium storing instructions which, when executed by the processing system when deployed in a cellular access network, cause the processing system to perform operations, the operations comprising:
obtaining load information associated with a plurality of non-cellular wireless access networks, wherein at least a portion of the load information is obtained from a plurality of endpoint devices through a non-cellular network interworking function;
configuring a machine learning model in accordance with the load information to generate an offload policy for an area that includes the plurality of non-cellular wireless access points; and
transmitting an instruction to at least one endpoint device to cause the at least one endpoint device to connect to one of the plurality of non-cellular wireless access networks in accordance with the offload policy.
